(19) United States
(12) Patent Application Publication
(10) Pub. No.: US 2008/0230094 A1
(43) Pub. Date: Sep. 25, 2008

(54) METHOD TO INHIBIT GROWTH OF MICROORGANISMS IN AQUEOUS SYSTEMS AND ON SUBSTRATES USING PERSULFATE AND A BROMIDE

(75) Inventors: Xiangdong Zhou, Cordova, TN (US); Thomas E. McNeel, Memphis, TN (US)

Correspondence Address: NIXON PEABODY, LLP, 401 9TH STREET, NW, SUITE 900, WASHINGTON, DC, 20004-2128, US

(73) Assignee: Buckman Laboratories International, Inc., Memphis, TN (US)

(21) Appl. No.: 11/690,572

(22) Filed: Mar. 23, 2007

(51) Int. Cl. A01N 59/00; C02F 1/76

(52) U.S. Cl. 134/42; 210/754

(57) ABSTRACT

The invention is a method to inhibit the growth of at least one microorganism in an aqueous system capable of supporting such growth. This includes controlling, and preferably preventing, slime formation in the aqueous system. The method mixes a persulfate salt, a bromide salt, and water under conditions sufficient to form an active bromine-containing, [Br⁺], solution and then adds an effective amount of the active bromine-containing solution to an aqueous system to inhibit the growth of at least one microorganism in the aqueous system. Also, the invention is a method to inhibit the growth of at least one microorganism on a substrate capable of supporting such growth. The method contacts the substrate with an effective amount of active bromine-containing solution to inhibit the growth of at least one microorganism on the substrate. Combining an amine source with the persulfate salt and bromide salts generates an active bromine-containing solution which also contains bromamines.

### FIELD OF THE INVENTION

The invention relates to methods for controlling the growth of microorganisms in a variety of aqueous systems or on various substrates. More particularly, the invention relates to the use of active bromine-containing, including bromamine-containing, solutions to control microorganism growth by mixing a persulfate salt and a bromide salt.

### BACKGROUND OF THE INVENTION

Aqueous systems and substrates are highly subject to microbiological growth attack, and degradation. These aqueous systems may be fresh, brackish or saltwater systems. Exemplary aqueous systems include, but are not limited to, paper-making water systems, recirculating cooling water systems, swimming pools, metal working fluids systems, waste water, as well as intake water for use in such aqueous systems. These aqueous systems frequently contain relatively large amounts of water and organic material causing them to be environments well-suited for microbiological growth and thus attack and degradation. Exemplary substrates are surface coatings, lumber, seeds, plants, leather, plastics and other industrial materials. In addition, substrates also include surfaces in aqueous systems, food processing plants, hospitals, and agricultural equipment.

Microbiological degradation of aqueous systems may manifest itself as a variety of problems, such as loss of viscosity, gas formation, objectionable odors, decreased pH, emulsion breaking, color change, and gelling. Additionally, microbiological deterioration of aqueous systems can cause fouling of the related water-handling system, which may include cooling towers, pumps, heat exchangers, and pipelines, heating systems, scrubbing systems, and other similar systems.

Another objectionable phenomenon occurring in aqueous systems, particularly in aqueous industrial process fluids, is slime formation. Slime formation can occur in fresh, brackish or salt water systems. Slime consists of matted deposits of microorganisms, fibers and other debris. It may be stringy, pasty, rubbery, tapioca-like, or hard, and may have a characteristic undesirable odor that is different from that of the aqueous system in which it formed. The microorganisms involved in its formation are primarily different species of spore-forming and nonspore-forming bacteria, particularly capsulated forms of bacteria which secrete gelatinous substances that envelop or encase the cells. Slime microorganisms also include filamentous bacteria, filamentous fungi of the mold type, yeast, and yeast-like organisms. Slime reduces yields in production and causes plugging, bulking, and other problems in industrial water systems.

Microbiological growth can also take place on substrates such as surface coatings, lumber, seeds, plants, leather, plastics and other industrial materials. In addition, microorganisms can grow on surfaces in aqueous systems, food processing plants, hospitals, and agricultural equipment. The temperatures at which these substrates are manufactured, stored or the environments in which they are used as well as their intrinsic characteristics make them susceptible to growth, attack and degradation by common organisms such as algae, fungi, yeast and bacteria. These microorganisms may be introduced during the manufacturing or other industrial process, by exposing to air, tanks, pipes, equipment, and humans. The microorganisms may also be introduced while using a material or product, for example, by multiple openings and reclosures of packages or from stirring or removing materials with contaminated objects.

Despite the existence of microbicides, industry is constantly seeking more cost-effective technology which offers equal or better protection at lower cost and lower concentration. The concentration of conventional microbicides and the corresponding treatment costs for such use, can be relatively high. Important factors in the search for cost-effective microbicides include the duration of microbicidal effect, the ease of use and the effectiveness of the microbicide per unit weight.

### SUMMARY OF THE INVENTION

In view of industry's search for more cost effective microbicides, the invention offers an improvement over current products or practices. The invention provides methods to inhibit the growth of at least one microorganism in an aqueous system or on a substrate capable of supporting such growth. This includes controlling, and preferably preventing, slime formation in an aqueous system and on a substrate. For an aqueous system, the method mixes a persulfate salt, a bromide salt, and water under conditions sufficient to form an active bromine-containing solution and then adds an effective amount of the active bromine-containing solution to an aqueous system to inhibit the growth of at least one microorganism in the aqueous system. The invention also provides a method to inhibit the growth of at least one microorganism on a substrate. In this embodiment, this method contacts a substrate susceptible to the growth of microorganism with an effective amount of an active bromine-containing solution to inhibit, control or prevent the growth of microorganisms on the substrate. In a preferred embodiment, an amine source is combined with the persulfate and bromide salts to generate an active bromine containing solution which also contains bromamines.

### DESCRIPTION OF THE INVENTION

The invention provides methods to inhibit the growth of at least one microorganism in an aqueous system or on a substrate capable of supporting such growth. This includes controlling, and preferably preventing, slime formation in an aqueous system and on the substrates. According the invention, the method mixes a persulfate salt, a bromide salt, and water under conditions sufficient to form an active bromine-containing solution and then adds an effective amount of the active bromine-containing solution to an aqueous system to inhibit the growth of at least one microorganism in the aqueous system. When applied to the substrates, the method contacts a substrate with an active bromine-containing solution to inhibit the growth of at least one microorganism on the substrate.

An “active bromine-containing solution” contains at least one bromine-containing species where the bromine has a valence of +1, Br⁺. Mixing a persulfate salt with a bromide salt according to the invention causes a reaction in which the persulfate anion oxidizes the bromide anion to form the active bromine-containing solution which is an oxidizing biocide that may then be added to an aqueous system to control the growth of microorganisms. In a preferred embodiment, (discussed below) an amine source is combined with the persulfate and bromide salts to generate an active bromine-containing solution where the active bromine is in the form of bromamines. The methods of the invention possess several advantages over known oxidizing biocides. These methods do not produce chlorine or chlorine-containing by-products, and are more stable. They are less corrosive, and more efficacious in alkaline and high demand systems than chlorine-based methods; and have better taste and less odor problems for drinking water disinfection.

Any persulfate salt having sufficient solubility in water to form an aqueous solution (including saturated solutions) and capable of reacting with the bromide salt may be used in a method of the invention. Useable persulfate salts include, but are not limited to, alkali metal persulfate salts, alkaline earth metal persulfate salts, and cationic amine persulfate salts. Preferable persulfate salts include ammonium persulfate, sodium persulfate, potassium persulfate, calcium persulfate, and magnesium persulfate, with ammonium persulfate being particularly preferred. Mixtures of two or more persulfate salts may also be used.

As with the persulfate salts, any bromide salt having sufficient solubility in water to form an aqueous solution (including saturated solutions) and capable of reacting with the persulfate salt may be used in a method of the invention. Useable bromide salts include, but are not limited to, alkali metal bromide salts, alkaline earth metal bromide salts, and cationic amine bromide salts. Preferable bromide salts are sodium bromide, ammonium bromide, potassium bromide, calcium bromide and magnesium bromide, which sodium bromide being particularly preferred. Mixtures of two or more bromide salts may also be used.

In the method of the invention, a persulfate salt, a bromide salt, and water are mixed to under conditions sufficient to form an active bromine-containing solution. In the mixing step, the molar ratio of persulfate to bromide ranges from 1:1 to 1:10, preferably from 1:2 to 1:4.

Mixing the salts may be accomplished in a variety of ways such as are known in the art. For example, the persulfate salt and the bromide salt may be added to the water as solids. Alternatively, a solution of one salt may be prepared and the other salt added to it in the form of a solid. A preferred embodiment of the invention mixes an aqueous persulfate solution and an aqueous bromide solution to form the active bromine-containing solution. This preferred method provides an easy way of practicing the invention when treating an aqueous system or a substrate. An aqueous persulfate solution and an aqueous bromide solution may be prepared in separate tanks then combined in the desired amounts in a mixing/storage tank under conditions sufficient to form the active bromine containing solution which is then added to the aqueous system to be treated.

The concentrations of the aqueous persulfate and aqueous bromide solutions should be chosen such that the active bromine-containing solution forms within a useable time and such that the Br⁺ concentration in the active bromine-containing solution is useable to treat the aqueous system or substrate. The active bromine-containing solution may be used after the antimicrobial efficacy has been maximized. The time needed after mixing the persulfate and bromide solutions for the maximal effects to develop is also known as “aging.” “Aging” refers to time over which the persulfate salt and the bromide salt react in order to generate the active bromine species. As the active bromine-containing solution ages, the Br⁺ concentration increases. The desired Br⁺ concentration, and therefore degree of aging, may be determined empirically depending upon the aqueous system and the desired biocidal activity. One of ordinary skill will appreciate that aging is reaction dependent. It varies, for example, according to the concentration of the persulfate and bromide solutions, the pH of the resulting mixture and the time of aging. Typically, the aqueous persulfate solution has a persulfate concentration before mixing ranging from about 5% to about 100% (w/v) and the aqueous bromide solution has a bromide concentration before mixing ranging from about 5% to about 100% (w/v). At either higher concentrations or at lower pH, the desired degree of aging is typically achieved sooner. Typical aging times range from 0.5-24 hours.

The persulfate salt, bromide salt, and water, as discussed above, are mixed under conditions sufficient to form an active bromine-containing solution. This refers to the conditions under which a reaction occurs in which the persulfate anion oxidizes the bromide anion to form the active bromine-containing solution. When an amine-containing compound is present, the reaction also results in the formation of bromamine compounds. Exemplary oxidation reactions using ammonia and forming bromamines are shown by the following scheme:

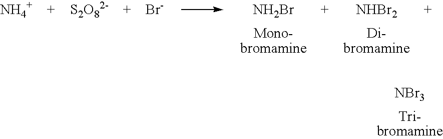

The type of bromamine species existing in the mixture is dependent on pH. At high pH (13-14), monobromamines predominate; at neutral pH (6-8), dibromamines predominate; and at low pH (0-1), tribromamine predominates.

The methods of the invention may be practiced at any pH. The pH of the active bromine-containing solution may be adjusted by adding an acid or base as is known in the art. The acid or base added should not react with the Br⁺ species generated within the active bromine-containing solution. It is preferable to use an acid or base corresponding to either the persulfate or bromide salt used to prepare the active bromine-containing solution. The pH of the bromine-containing solution typically ranges from 0 to 13. The invention, then, is preferably carried out in acidic conditions, preferably at pH ranges from 0 to 5 or lower tan 5.

In the method of the invention the active bromine-containing solution is added to an aqueous system or a substrate is contacted with the active bromine-containing solution to control the growth of at least one microorganism. Control of the growth of a microorganism in an aqueous system means control to, at, or below a desired level for a desired period of time for the particular aqueous system. This can vary from the complete prevention or inhibition of microbiological growth to control at a certain desired level and for a desired time. The method described here can, in many cases, reduce the total microbiological count to undetectable limits and maintain the count at that level for a significant period of time. Accordingly, the method may be used to preserve an aqueous system.

The effective amount of the active bromine-containing solution necessary to achieve the desired level of control will vary somewhat depending on the aqueous system or substrate to be protected, the conditions for microbial growth, and the degree of protection desired. For a particular application, the amount of choice may be determined by routine testing of various amounts prior to treatment of the affected aqueous system or substrate. With aqueous systems, the active bromine concentration, [Br⁺], in the aqueous system after addition may range from about 0.5 to about 5000 parts per million, more preferably from about 5 to about 1000 parts per million of the aqueous system, and most preferably from, about 10 to about 25 parts per million. Similar amounts effectively control slime formation. For slime control, effective amounts preferably range from about 1 to about 200 parts per million, and more preferably, from about 1 to about 25 parts per million of the aqueous system. To control microbial growth on a substrate, the active bromine concentration, [Br⁺], in the active bromine-containing solution may range from about 1 ppm to about 10,000 ppm, more preferably from about 5 ppm to 5,000 ppm, and most preferably from about 10 ppm to 1,000 ppm. The term “active bromine concentration, [Br⁺]” refers to the active bromine [Br⁺] concentration without regard to the particular active bromine species.

The active bromine concentration [Br⁺] in the active bromine-containing solution may be higher than that desired in the aqueous system. The amount of active bromine-containing solution to be added may be determined by the desired active bromine concentration, [Br⁺], taking into account the volume of the aqueous system. Alternatively, a method of the invention may include, prior to the addition step, the step of diluting the active bromine-containing solution to achieve a desired active bromine concentration. The diluted active bromine-containing solution may then be added to the aqueous system. The active bromine-containing solution may be added to the aqueous system by any means known in the art including, but not limited to simple mixing with or pumping into the aqueous system. In a preferred embodiment the active bromine-containing solution is added to, and used to treat, the intake from or aqueous system. In other words, the active bromine-containing solution may be used to control microbiological growth in water prior to the use of that water in the aqueous system.

The method of the invention may be used in a variety of industrial aqueous systems and processes as well as in recreational aqueous systems for microorganism control. Such aqueous systems include, but are not limited to, metal working fluids, cooling water systems (cooling towers, intake cooling waters and effluent cooling waters), waste water systems including waste waters or sanitation waters undergoing treatment of the waste in the water, e.g. sewage treatment, recirculating water systems, swimming pools, food processing systems, drinking water systems, leather-processing water systems, white water systems, pulp slurries and other paper-making or paper-processing water systems. The method of the invention may also be used in the treatment of intake water for such various aqueous systems. As discussed above, embodiment, intake water is first treated by the method of invention so that the microbial growth is inhibited before the intake water enters the aqueous system.

The method of the invention may also be applied to inhibit the growth of microorganisms on various substrates. Examples of substrates include, but not limited to, surface coatings, lumber, seeds, plants, leather, plastics and other industrial materials. In addition, substrates also include hard surfaces in aqueous systems, food processing plants, hospitals, and agricultural equipment.

One embodiment of invention inhibits the growth of microorganisms on a substrate by contacting the substrate with an effective amount of an active bromine-containing solution. The duration of the contact of the substrate is that amount of time sufficient to inhibit, control or prevent the growth of the microorganisms. Alternately, the duration of the contact is sufficient to reduce the microbiological counts to undetectable limits and maintain it at such level for an extended period of time. Where the active bromine-containing solution is used to control growth of a microorganism on a surface, such as a counter top, a table, a piece of equipment, etc., the solution may be applied to the surface by means known in the art. For example, the active bromine-containing solution may be sprayed, poured, wiped or brushed onto the surface, or where possible, the surface may be treated by dipping it into a bath containing the active bromine-containing solution.

In another embodiment of the method of the invention, a persulfate salt and a bromide salt are first mixed with water to form a solution and given an appropriate period of aging so that an effective concentration of the active bromine-containing solution is formed. In industries, such as these discussed below, the substrate to be treated is dipped into a bath or contacted with an aqueous liquid as part of its normal processing, e.g., an aqueous tanning liquor in leather tanning. In these industries the active bromine-solution may be prepared by adding a persulfate salt and a bromine salt to an aqueous liquid typically used in the particular process. The resulting solution should be allowed to age to prior use in order to generate the active bromine as discussed above. The active bromine-containing solution is then brought to contact with the substrate to inhibit, control or prevent the growth of microorganisms such that the microbiological counts are reduced to undetectable limits and maintained at such level for an extended period of time.

In the leather industry, the method of the invention can be used to control the growth of microorganisms on a hide during a tanning process. To achieve this control the hide is contacted with an active bromine-containing solution for a duration effective to control the growth of at least one microorganism on the hide.

The method of invention may also be used in the tanning process in similar amounts and manner similar to that used to apply other biocides used in the tanning industry. The type of hide may be any type of hide or skin that is tanned, for example cowhide, snake skin, alligator skin, sheep skin, and the like. The amount of active bromine-containing solution used, to some extent, will depend on the degree of microbiological resistance required and may be readily determined by one skilled in the art.

A typical tanning process comprises a number of stages, including, but not limited to, a pickling stage, a chrome-tanning stage, a vegetable-tanning stage, a post-tan washing stage, a retaining stage, a dyeing stage, and a fatliquoring stage. The method of invention may be used during all process stages in the tanning process in addition to those stages where a known microbiological problem is occurring. In each stage, the active bromine-containing solution may be a component of the appropriate tanning liquor applied to the hide undergoing tanning.

Incorporating the active-bromine containing solution in a tanning liquor protects the hide from microbiological deterioration during the tanning process. Preferably, the solution is dispersed, e.g., under agitation, into an appropriate liquor to be used in a tanning process. Alternatively, as discussed above for this (and other processes discussed below) a persulfate salt and a bromine salt may be added to the tanning liquor (or other aqueous solutions). Typical tanning liquors include, for example, a pickling liquor, a chrome-tanning liquor, a vegetable-tanning liquor, a post-tan washing liquor, a retanning liquor, a dye liquor, and a fatliquor. This method of application ensures that the active bromine-containing solution applied to the hides protects against microbiological attack, deterioration, or other microbiological degradation.

In an analogous nature, the method of the invention may also be employed to control the growth of microorganisms on a textile substrate in a textile manufacturing process. Contacting the textile substrate with an active bromine-containing solution according to the invention effectively controls the growth of a microorganism on the textile substrate. In a textile process, the method of invention may be used in similar amounts and a manner similar to other biocides commonly used in such processes. As one of ordinary skill would appreciate, particular amounts generally depend on the textile substrate and the degree of microbiological resistance required.

The step of contacting the textile substrate with the active bromine-containing solution may be accomplished using means known in the textile art. To control microbiological growth, a textile process generally dips the textile substrate into a bath containing an active bromine-containing solution, alone or with other chemicals used to treat the textile substrate. Alternatively, the textile substrate may be sprayed with a formulation containing an active bromine-containing solution. In the bath or the spray, the combination of the persulfate salt and the bromide salt are present in a combined amount effective to control the growth of at least one microorganism on the textile substrate. Preferably, the bath and the spray are aqueous-based compositions.

To preserve the value of its raw materials and products, the lumber industry also must control the growth of microorganisms in order to prevent microbiological degradation of lumber. An active bromine-containing solution and a bromide according to the invention is effective to control the growth of microorganisms on lumber. The active bromine-containing solution may be used to protect the lumber in similar amounts and a similar manner employed for other biocides used in the lumber industry. Contacting lumber with an effective amount of the active bromine-containing solution may be accomplished, for example, by spraying the lumber with an aqueous formulation containing the active bromine, by dipping the lumber into a dip bath containing the active bromine, or other means known in the art. Dipping the lumber in an aqueous bath is preferred.

The active bromine-containing solution, or a persulfate salt and a bromide salt, are preferably dispersed in a bath (for example, by agitation) prior to the dipping of the lumber into the bath. In general, the lumber is dipped into the bath, raised, allowed to drip dry, and then air dried. The dip time will depend, as is known in the art on a variety of factors such as the biocide, the degree of microbiological resistance desired, the moisture content of the lumber, type and density of the wood, etc. Pressure may be applied to promote penetration of the combination into the lumber being treated. Applying a vacuum to the upper surface of the lumber may also be used to degas the lumber and promote increased wetting of the lumber by a bath containing the active bromine-containing solution.

The method of the invention can also be used in the agricultural industry. To control the growth of microorganisms on a seed or plant, the seed or plant may be contacted with an active bromine-containing solution in an amount effective to control the growth of at least one microorganism on the seed or plant. This contacting step may be accomplished using means and amounts known in the agricultural industry for biocides. For example, the seed or plant may be sprayed with an aqueous formulation containing the active bromine-containing solution, or dipped into a bath containing the active bromine-containing solution. After being sprayed or dipped, the seed or plant is generally dried by means known in the art such as drip drying, heated drying, or air drying. For plants or crops, the active bromine-containing solution may also be applied using a soil drench. Soil drenching is particularly advantageous when the microorganisms of concern inhabit the soil surrounding the plant.

Accordingly, this invention provides a benefit to industries such as the leather industry, the lumber industry, the papermaking industry, the textile industry, the agricultural industry, the healthcare industry and the coating industry to answer the problems caused by microbiological attack and deterioration in these various applications described above. The practice of methods of the invention to control the growth of microorganisms is shown in the examples below.

### EXAMPLE 1

### Effect of Mixing Ammonium Persulfate and Sodium Bromide

A concentrated solution of active biocidal composition was prepared by mixing 44% (w/v) of aqueous ammonium persulfate with 40% (w/v) aqueous sodium bromide in equal volume. The final mixture contains 22% ammonium persulfate and 20% NaBr at pH 2.2. The molar ratio of the components was 1:2 for (NH₄)₂S₂O₈:NaBr. Four hours after mixing, the concentrated solution was diluted with water to contain 5% ammonium persulfate. This diluted solution (5%) was then added to 50 ml pulp slurry to give a biocidal concentration of 10 ppm (as ammonium persulfate) in pulp slurry. The pulp slurry was then inoculated with 3×10⁶ cells/ml of Pseudomonas aeruginosa, incubated at room temperature for 24 hr, plated in nutrient agar. The colony forming units per milliliter (cfu/ml) was counted and compared with each individual component acting alone.

The pulp slurry contains white bleached dry pulp at 5 g/L; cationic starch at 10 bl/ton dry pulp; CaCO₃ at 300 bl/ton dry pulp; ASA size at 3-4 lb/ton dry pulp; retention aids at 0.5-1.0 bl/ton dry pulp; defoamer at 250 g/ton dry pulp. The pulp slurry has a consistency of about 0.5 to 0.7%. The final pH of the pulp substrate after autoclave is about 8.0. The results are shown in Table 1. The data indicates that mixing ammonium persulfate with sodium bromide produces a strong biocidal solution. Neither component acting alone provides significant antimicrobial efficacy.

TABLE 1
(1.0 Log Reduction = 90% kill)

| | Dose (ppm as | | Log |
|---|---|---|---|
| Biocide | pure compound) | CFU/ml | Reduction |
| Mix of (NH₄)₂S₂O₈ + | 10 (NH₄)₂S₂O₈ + | 4.0 × 10² | 4.02 |
| NaBr | 9.1 NaBr | | |
| (NH₄)₂S₂O₈ | 100 | 4.5 × 10⁵ | 0.97 |
| NaBr | 1000 | 4.2 × 10⁶ | 0.00 |
| Control | 0 | 4.2 × 10⁶ | 0.00 |

### EXAMPLE 2

### Antimicrobial Efficacy at Various Times After Mixing

The antimicrobial efficacy of the mixture containing 22% (w/v) aqueous ammonium persulfate and 20% (w/v) aqueous NaBr was tested at different times after mixing, aging times. The mixture preparation, at pH 2.2, and the test system are the same as that described in Example 1. At each time, a portion of the mixture was taken and diluted to 5% (as ammonium persulfate). The diluted solution was then added to pulp slurry to give a final concentration of 5, 10, 20, and 40 ppm (as ammonium persulfate) in pulp slurry. The results in Table 2 demonstrate that at very low dosages the concentrated mixture provided a strong biocidal activity 4 hr after mixing. At only 5 ppm level, it achieved 2.5 logs reduction, which represents greater than 99% kill. In contrast, the mixed solution did not generate strong antimicrobial activity immediately after mixing. It requires about 4 hr to provide significant activity. At about 8 hr after mixing, the mixed solution reached the maximum activity. The biocidal efficacy of the mixture was maintained or stabilized for at least 7 days.

TABLE 2

| | Log Reduction by mixture containing 22% | | | | | |
|---|---|---|---|---|---|---|
| | (NH₄)₂S₂O₈ & 20% | | | | | |
| | NaBr at different times after mixing | | | | | |
| Dose (ppm) | 1 hr | 2 hr | 4 hr | 8 hr | 24 hr | 7 days |
| 5 | 0.0 | 0.0 | 2.46 | 3.63 | >4.6 | >4.6 |
| 10 | 0.06 | 0.08 | 4.02 | >4.6 | >4.6 | >4.6 |
| 20 | 0.19 | 1.9 | >4.6 | >4.6 | >4.6 | >4.6 |
| 40 | 3.37 | >4.6 | >4.6 | >4.6 | >4.6 | >4.6 |

### EXAMPLE 3

### Antimicrobial Efficacy As A Function of Concentration

The combination of (NH₄)₂S₂O₈/NaBr was investigated by mixing aqueous solutions of the components at different concentrations (% w/v). Three mixtures were generated. Mixture #1 was prepared by mixing 22% (NH₄)₂S₂O₈ with 20% NaBr in equal volume. The final concentrations in mixture #1 were 11% (NH₄)₂S₂O₈ and 10% NaBr. Mixture #2 was made by mixing 33% (NH₄)₂S₂O₈ with 30% NaBr in equal volume. The final concentrations in Mixture #2 were 16.5% (NH₄)₂S₂O₈ and 15% NaBr. Mixture #3 was prepared by mixing 44% (NH₄)₂S₂O₈ with 40% NaBr in equal volume. In the final solution, Mixture #3 contains 22% (NH₄)₂S₂O₈ and 20% NaBr. All three mixtures, having a pH 2.2, were tested at a dosage of 20 ppm, and at 1, 2, 4, and 8 hr after mixing for their antimicrobial activity in the pulp slurry described in Example 1. The results in Table 3 indicate that mixtures with higher concentrations of the components produced biocidal efficacy earlier, and reached the maximum activity more quickly. At about 8 hr after mixing, all three mixtures reached their maximum activity.

TABLE 3

Log reduction by three mixtures
at different times after mixing
(20 ppm as (NH₄)₂S₂O₈)

| Mixture | 1 hr | 2 hr | 4 hr | 8 hr |
|---|---|---|---|---|
| #1 (11% + 10%) | 0 | 0 | 1.52 | >4.60 |
| #2 (16.5% + 15%) | 0 | 1.75 | 3.48 | >4.60 |
| #3 (22% + 20%) | 0.19 | 1.91 | >4.60 | >4.60 |

### EXAMPLE 4

### Effect of Substituting Ammonium Persulfate with Sodium Persulfate

A concentrated biocidal solution was made by mixing aqueous sodium persulfate (47%, w/v) with aqueous sodium bromide (40% w/v) in equal volume. The resulting mixture contained 23.5% sodium persulfate and 20% NaBr at pH 4.2. The molar ratio of the components was 1:2 for Na₂S₂O₈:NaBr. After aging 1, 2, 4, 8, 24 hr, and 7 days after mixing, the concentrated solution was diluted with water to 5% sodium persulfate. This 5% solution was then added to 50 ml pulp slurry to give a biocidal concentration of 10, 20, and 40 ppm (as sodium persulfate) in pulp slurry. The pulp slurry was then inoculated with 3×10⁶ cells/ml of P. aeruginosa, incubated at room temperature for 24 hr, and plated in nutrient agar. According to the data in Tables 2 and 4, the combination of Na₂S₂O₈/NaBr produced a weaker biocidal solution than the combination of (NH₄)₂S₂O₈/NaBr.

TABLE 4

| | Log reduction by mixture containing 23.5% | | | | | |
|---|---|---|---|---|---|---|
| | Na₂S₂O₈ & 20% NaBr | | | | | |
| | at different times after mixing | | | | | |
| Dose (ppm) | 1 hr | 2 hr | 4 hr | 8 hr | 24 hr | 7 days |
| 10 | 0.0 | 0.02 | 0.28 | 0.79 | 2.13 | 3.42 |
| 20 | 0.01 | 0.01 | 1.89 | >4.6 | >4.6 | >4.6 |
| 40 | 0.8 | 1.82 | >4.6 | >4.6 | >4.6 | >4.6 |

### EXAMPLE 5

### Comparison Between Ammonium Persulfate and Sodium Persulfate

Both aqueous ammonium persulfate (44% w/v) and aqueous sodium persulfate (47% w/v) were each separately mixed with 40% w/v of aqueous sodium bromide in equal volume to produce two concentrated solutions. One concentrated solution contains 22% ammonium persulfate and 20% NaBr at pH 2.2, and the other concentrated solution contains 23.5% sodium persulfate and 20% NaBr at pH 4.2. The resulting mixtures were tested in the pulp slurry as described in Example 1 at the dosage of 10 ppm (as persulfate salt) for both mixtures. The results are shown in Table 5. At the same dosage level (10 ppm), ammonium persulfate outperformed sodium persulfate by a significant margin in the pulp slurry.

TABLE 5

| | Log reduction with 10 ppm | | | | | |
|---|---|---|---|---|---|---|
| | (NH₄)₂S₂O₈ versus | | | | | |
| | 10 ppm of Na₂S₂O₈ at | | | | | |
| | different times after mixing | | | | | |
| Mixture | 1 hr | 2 hr | 4 hr | 8 hr | 24 hr | 7 days |
| (NH₄)₂S₂O₈/NaBr | 0.06 | 0.08 | 4.02 | >4.6 | >4.6 | >4.6 |
| Na₂S₂O₈/NaBr | 0.0 | 0.02 | 0.28 | 0.79 | 2.13 | 3.42 |

### EXAMPLE 6

### Effects of Mixing Sodium Persulfate and Ammonium Bromide

A solution of active biocidal ingredients was prepared by mixing 20% (w/v) of aqueous sodium persulfate with 16% (w/v) aqueous ammonium bromide in equal volume. The final mixture contains 10% sodium persulfate and 8% NH₄Br at pH 3.6. The molar ratio of the components was 1:2 for Na₂S₂O₈:NH₄Br. At 2, 5, and 8 hr after mixing, add 10 and 20 μl of the mixed solution to 50 ml pulp slurry to give a biocidal concentration of 20, and 40 ppm (as sodium persulfate). The pulp slurry was then inoculated with 3×10⁶ cells/ml of P. aeruginosa, incubated at room temperature for 24 hr, plated in nutrient agar. The results are shown in Table 6.

TABLE 6

| | Log reduction by mixture containing | | |
|---|---|---|---|
| | 10% Na₂S₂O₈ & 8% NH₄Br | | |
| | at different times after mixing | | |
| Dose (ppm) | 2 hr | 5 hr | 8 hr |
| 20 | 0.0 | 0.0 | 0.52 |
| 40 | 0.0 | 1.05 | >4.6 |

### EXAMPLE 7

### Effect of Molar Ratio of (NH₄)₂S₂O₈:NaBr on Antimicrobial Efficacy

Biocidal solutions containing mixture of (NH₄)₂S₂O₈/NaBr with different molar ratios were prepared by mixing proper amounts of aqueous ammonium persulfate with certain amounts of aqueous sodium bromide. The solutions having different molar ratios of (NH₄)₂S₂O₈:NaBr, at pH 2.2, were tested 24 hr after mixing in pulp slurry against P. aeruginosa. The test procedure is the same as described in Example 1. The data presented in Table 7 demonstrate that the best molar ratio of (NH₄)₂S₂O₈:NaBr is 1:2.

TABLE 7

| | Log reduction by tuixtues of |
|---|---|
| | (NH₄)₂S₂O₈/NaBr |
| Molar Ratio of | having different molar ratios |

| (NH₄)₂S₂O₈:NaBr | 3 ppm as S₂O₈ | 5 ppm as S₂O₈ |
|---|---|---|
| 2:1 | 0 | 0 |
| 1:1 | 0 | 0 |
| 1:2 | 2.88 | >4.7 |
| 1:4 | 0.74 | 4.25 |
| 1:8 | 0 | 4.35 |

### EXAMPLE 8

### Effects of Using Mixtures of (NH₄)₂S₂O₈/NaBr at Concentrations Higher Than 22%/20%

The component concentrations an aqueous mixture of (NH₄)₂S₂O₈/NaBr were 22% (NH₄)₂S₂O₈ and 20% NaBr. This example studied the biological efficacies of mixtures of (NH₄)₂S₂O₈/NaBr containing significantly higher concentrations of each component. A series of biocidal mixtures were prepared by mixing aqueous solutions of the two components at significantly higher concentrations to contain 33, 44, 50, and 55% of (NH₄)₂S₂O₈ and 30, 40, 45, and 50% of NaBr, respectively. Each solution, at pH 2.2, had the same molar ratio of (1:2) (NH₄)₂S₂O₈:NaBr as the regular mixture (22% (NH₄)₂S₂O₈ and 20% NaBr). The biocidal mixtures having higher concentrations were tested for the efficacy in pulp substrate against P. aeruginosa as described in Example 1. The data obtained is summarized in Table 8. It is concluded from the data that mixtures with higher concentrations of components generate better efficacy and reach the maximum activity faster.

TABLE 8

| | Log reduction by high concentration mixtures of | | |
|---|---|---|---|
| % (NH₄)₂S₂O₈ | (NH₄)₂S₂O₈/NaBr | | |
| & | (Dosage in pulp substrate is 3 ppm as (NH₄)₂S₂O₈) | | |
| % NaBr | 2 hr after mixing | 4 hr after mixing | 6 hr after mixing |
| 22% & 20% | 0 | 0.15 | 0.5 |
| (regular conc.) | | | |
| 33% & 30% | 0.02 | 0.87 | 2.25 |
| 44% & 40% | 2.4 | 2.8 | 3.15 |
| 50% & 45% | 2.6 | >4.6 | >4.6 |
| 55% & 50% | 3.9 | >4.6 | Not tested* |

*The solution was not stable 6 hr after mixing. Solid precipitates were observed after 6 hr.

### EXAMPLE 9

### Effect of pH on the Antimicrobial Efficacy of the Mixture of (NH₄)₂S₂O₈/NaBr

The antimicrobial efficacy of the mixture was studied under pH control. The two chemicals, (NH₄)₂S₂O₈ and NaBr, were mixed in different buffer solutions with pH values of 1, 4, 7, and 10. For the solution at pH 1, a small amount of 10% H₂SO₄ was added periodically to the buffer solution to control the pH of the mixture at around 1. For the solutions at pH 4, 7, and 10, a small amount of 50% NaOH was added periodically to the solutions to control the pH to the designed values. Six hours after mixing, all the mixed solutions were tested against P. aeruginosa in pulp substrate (PH˜8.0). The results are presented in Table 9. To obtain the best efficacy, we either mixed the two components in water without pH control or control the pH of the mixture to the values below 3. In general, pH values of above about 4 showed decreasing efficacy. Interestingly, the efficacy was better at pH 10 than at pH 4 or 7.

TABLE 9

| | Log reduction by mixture of | | |
|---|---|---|---|
| | 22% (NH₄)₂S₂O₈ + | | |
| | 20% NaBr at different pH | | |
| pH | 20 ppm | 50 ppm | 100 ppm |
| 1.0 | >4.7 | >4.7 | >43 |
| 4.0 | 0.06 | 0.1 | Not Tested |
| 7.0 | 0.0 | 0.01 | 0.04 |
| 10.0 | Not Tested | 0.82 | 2.17 |
| Control (2.4) | >4.7 | >4.7 | >4.7 |

### EXAMPLE 10

### Comparison Between (NH₄)₂S₂O₈/NaBr and Na₂S₂O₈/NaBr With pH Control

The data in Example 5 demonstrated that the mixture of (NH₄)₂S₂O₈/NaBr had better antimicrobial efficacy than the mixture of Na₂S₂O₈/NaBr. The involvement of the NH₄ group in the mixture could be one reason for the better efficacy, but the lower pH of (NH₄)₂S₂O₈/NaBr could also has contributed to the better efficacy. The pH of (NH₄)₂S₂O₈/NaBr was about 2.2 immediately after mixing, while the pH of Na₂S₂O₂/NaBr was about 4.2 immediately after mixing. To determine which factor, the NH₄ group or the lower pH or both, played the vital role for the better efficacy, the pH of Na₂S₂O₈/NaBr was adjusted from 4.2 to 2.2 by adding 10% H₂SO₄. At 22 hr after mixing, the activities of the two mixtures were compared in pulp substrate against P. aeruginosa. Table 10 compared the efficacy data of Na₂S₂O₈/NaBr (with pH control at 2.2, or without pH control at 4.2) with that of (NH₄)₂S₂O₈/NaBr (without pH control at 2.2). It is concluded that the pH of the mixture is not a factor for the better efficacy of (NH₄)₂S₂O₈NaBr. Lowering the pH of Na₂S₂O₈/NaBr did not improve its efficacy. Therefore, the involvement of NH₄ group was most likely the contributing factor to better efficacy of (NH₄)₂S₂O₈/NaBr. This further implies the formation of bromamines (or other nitrogen bromine compounds) when mixing (NH₄)₂S₂O₈ with NaBr.

TABLE 10

| | | Log reduction by the | | |
|---|---|---|---|---|
| | | Mixed Solutions | | |
| Mixed solutions | pH | 3 ppm | 5 ppm | 10 ppm |
| (NH₄)₂S₂O₈/NaBr | 2.2 | 2.03 | >4.7 | >4.7 |
| (without pH control) | | | | |
| Na₂S₂O₈/NaBr | 4.2 | 0.03 | 1.09 | 3.28 |
| (without pH control) | | | | |
| Na₂S₂O₈/NaBr | 2.2 | 0.04 | 1.00 | 3.22 |
| (with pH control) | | | | |

The claimed invention is:

1. A method to inhibit the growth of at least one microorganism in an aqueous system comprising the steps of:
mixing a persulfate salt, a bromide salt, and water under conditions sufficient to form an active bromine-containing solution; and
adding an effective amount of the active bromine-containing solution to the aqueous system to inhibit the growth of at least one microorganism.

2. The method of claim 1, wherein the active bromine-containing solution has a bromine concentration [Br⁺] ranging from about 0.5 ppm to about 5000 ppm.

3. The method of claim 1, wherein:
the persulfate salt is selected from the group consisting of alkali metal persulfate salts, alkaline earth metal persulfate salts, and cationic amine persulfate salts; and
the bromide salt is selected from the group consisting of alkali metal bromide salts, alkaline earth metal bromide salts, and cationic amine bromide salts.

4. The method of claim 3, wherein:
the persulfate salt is selected from the group consisting of ammonium persulfate, sodium persulfate, potassium persulfate, calcium persulfate, and magnesium persulfate; and
the bromide salt is selected from the group consisting of sodium bromide, ammonium bromide, potassium bromide, calcium bromide and magnesium bromide.

5. The method of claim 1, wherein:
the persulfate salt and the bromide salt have a molar ratio ranging from 1:1 to 1:10.

6. The method of claim 5, prior to the step of adding, further comprising the step of:
diluting the active bromine-containing solution to a bromine concentration [Br⁺] ranging from about 1 ppm to about 25 ppm.

7. The method of claim 1, wherein the active bromine-containing solution has a pH of about 0 to about 13.

8. The method of claim 7, wherein the active bromine-containing solution has a pH of about 0 to about 5.

9. The method of claim 1, wherein the aqueous system is selected from the group consisting of recirculating water system, a swimming pool, a food processing system, a drinking water system, a waste water system, a cooling tower water system, a leather-processing water system, a paper-making water system, and intake water.

10. The method of claim 1, wherein the mixing step further comprises mixing an aqueous persulfate salt solution and an aqueous bromide salt solution to form the active bromine-containing solution.

11. The method of claim 10, wherein:
the aqueous persulfate salt solution has a concentration ranging from about 5% to about 100% (w/v); and
the aqueous bromide salt solution has a concentration ranging from about 5% to about 100% (w/v).

12. The method of claim 10, wherein:
the persulfate salt is selected from the group consisting of alkali metal persulfate salts, alkaline earth metal persulfate salts, and cationic amine persulfate salts; and
the bromide salt is selected from the group consisting of alkali metal bromide salts, alkaline earth metal bromide salts, and cationic amine bromide salts.

13. The method of claim 12, wherein:
the persulfate salt is selected from the group consisting of ammonium persulfate, sodium persulfate, potassium persulfate, calcium persulfate, and magnesium persulfate; and
the bromide salt is selected from the group consisting of sodium bromide, ammonium bromide, potassium bromide, calcium bromide and magnesium bromide.

14. The method of claim 10, wherein the persulfate salt and the bromide salt have a molar ratio ranging from 1:1 to 1:10.

15. The method of claim 10, wherein the aqueous system is selected from the group consisting of a recirculating water system, a swimming pool, a food processing system, a drinking water system, a waste water system, a cooling tower water system, a leather-processing water system, a paper-making water system and intake water.

16. A method to inhibit the growth of at least one microorganism on a substrate comprising the step of:
contacting the substrate with an effective amount of the active bromine-containing solution to inhibit the growth of at least one microorganism.

17. The method of claim 16, prior to the step of contacting, further comprising the step of:
mixing a persulfate salt, a bromide salt, and water under conditions sufficient to form an active bromine-containing solution.

18. The method of claim 16, wherein the substrate is selected from the group consisting of surface coating, lumber, a seed, a plant, leather, plastic, a surface of an aqueous system, a surface of food processing plants, a surface in a hospital and a surface of an agricultural equipment.

19. The method of claim 1, wherein the persulfate salt is a cationic amine persulfate salt and the bromide salt is an alkali metal salt.

20. The method of claim 19, wherein the active bromine-containing solution has a pH of about 0 to about 13.

21. The method of claim 20, wherein the active bromine-containing solution has a pH of about 0 to about 5.

22. The method of claim 19, wherein the cationic amine persulfate salt is ammonium persulfate and the alkali metal bromide salt is selected from the group consisting of sodium bromide and potassium bromide.
